(19) United States
(12) Patent Application Publication
(10) Pub. No.: US 2012/0095205 A1
(43) Pub. Date: Apr. 19, 2012

(54) Method of Modification of Hyaluronic Acid by Means of (O-ACYL-O'-ALKYL Carbonate-Substituted Pyridine) Complex

(75) Inventors: Radovan Buffa, Humenne (SK); Vladimir Velebny, Zamberk (CZ); Lucie Pospisilova, Svitavy (CZ); Eva Prikopova, Kunvald (CZ); Martin Pravda, Chrudim (CZ); Pavel Nikodym, Usti nad Labem (CZ); Lukas Palek, Plzen (CZ)

(73) Assignee: CONTIPRO C, (CZ)

(21) Appl. No.: 13/256,966

(22) PCT Filed: Mar. 13, 2010
(86) PCT No.: PCT/CZ2010/000030

§ 371 Date: Oct. 18, 2011

(30) Foreign Application Priority Data
Mar. 17, 2009 (CZ) PV 2009-168

(51) Int. Cl. C08B 37/00

(52) U.S. Cl. 536/55.3

(57) ABSTRACT

This invention relates to a novel method of preparation of hyaluronic acid derivatives by means of a reaction of the hyaluronic acid with the complex (O-acyl-O′-alkyl carbonate-substituted pyridine) of the general formula R—CO—O—CO—O—R1 and R25C5N. The reaction takes place in DMSO in the presence of an external base, forming O-acylated products. The method leads to higher substitution degrees and shorter reaction times compared to the known analogues, hi case the agent comprises two or more functional groups R(CO—O—CO—O—R1)n, crosslinked hyaluronic acid derivatives are formed.

### TECHNICAL FIELD

This invention relates to a novel method of modification of hyaluronic acid, forming derivatives in which —OH group of the polysaccharide is substituted by —O—CO—R group. The modification of the hyaluronic acid is performed by means of the complex (O-acyl-O′-alkyl carbonate—substituted pyridine) in a polar aprotic medium in the presence of an organic base. In case the agent comprises two or more acylalkyl carbonate groups, crosslinked hyaluronic acid derivatives are formed, having the molecular weight higher by order compared to the original polysaccharide.

### BACKGROUND ART

Polysaccharides are polymers composed of simple monosaccharides (monomer units) linked by the glycosidic bond. They are classified based on the number of the repeating units to oligosaccharides (2 to 10 units) and polysaccharides (10 or more units). The importance of polysaccharides is very high. Polysaccharides have a nutritional, protective, building (cellulose, chitin) or storing (starch) function. Polymers are generally characterised by an average molecular weight which typically falls within the range between 16.10³ g.mol⁻¹ to 16.10⁶ g.mol⁻¹. The number of the repeating units depends on the degree of polymerisation.

An important polysaccharide is hyaluronic acid

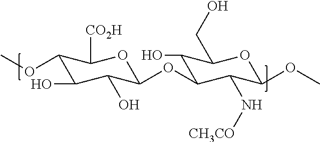

composed of repeating units β-(1,3)-D-glucuronic acid and β-(1,4)-N-acetyl-D-glucosamine. It is characterised by a high molecular weight of 5.10⁴ to 5.10⁶ g.mol⁻¹ which depends on the isolation method and on the initial material. Hyaluronic acid, or its salt hyaluronan, is an essential part of the connective tissue, synovial joint fluid, and plays an important role in a number of biological processes such as hydration, proteoglycan organisation, cell differentiation, proliferation and angiogenesis. This highly hydrophilic polysaccharide is water-soluble in the form of a salt within the whole pH range.

Hyaluronic acid is a representative of the glycosaminoglycans group which further includes chondroitin sulphate, dermatan sulphate, keratan sulphate and heparan sulphate.

### Acylation of the Hyaluronic Acid

Acylation of hyaluronic acid is the most frequently used method for introducing an alkyl chain which modifies the characteristics of mostly hydrophilic compounds to hydrophobic compounds. Most frequently, the reaction is performed by means of a reaction with anhydrides of the respective acids, chlorides of acids or the acid itself with an addition of catalysts.

The preparation of acyl-derivatives of hyaluronic acid oligomers is patented by Couchmann et al. (U.S. Pat. No. 4,761,401; 1988) where the acylation takes place both on the hydroxyl group and on the amino group of the deacetylated hyaluronan. O-acylation includes the reaction with an organic acid with an addition of an acid catalyst (mineral acid, organic acid or Lewis acid) and an activating agent (N,N′-dicyclo hexyl carbodiimide, 2-chloro-1-methylpyridinium iodide and N,N′-carbonyl diimidazol), or uses acid anhydrides or chlorides in the presence of a base. Michinori et al. (JP 7309902; 1995) prepared an acylated hyaluronic acid by means of the reaction with carboxylic acid anhydrides or carboxylic acid acylhalogenides in an aqueous medium comprising a water-miscible organic solvent in the presence of a catalyst. The saponification of acyl groups of the hyaluronic acid gave rise to derivatives having any number of acyl groups. Also Perbellini et al. (WO 2004/056877 A1; 2004) used the retinoic acid chloride and butyric acid anhydride for the preparation of specific derivatives of hyaluronic acid. The hyaluronic acid in the form of tetrabutyl ammonium salts was, used for the synthesis in N,N′-dimethyl formamide medium.

### Crosslinking of the Hyaluronic Acid

Crosslinking of the hyaluronic acid was described in several methods. The most simple method is crosslinking by means of POCl₃ (U.S. Pat. No. 5,783,691). Balasz et al. crosslinked the hyaluronic acid by means of divinyl sulfone (U.S. Pat. No. 4,582,865). Other reactive electrophiles which are suitable for crosslinking include aldehydes (U.S. Pat. No. 4,713,448). Further agents which are frequently used and which are able to react with two polymers are epoxides and bis epoxides (WO 86/00912, WO 2007/129828), wherein the best known representative of these is epichlorohydrin.

The use of EDC enhances the reactivity of the carboxylic group of hyaluronic acid which is then capable of crosslinking reactions with polyanionic compounds (U.S. Pat. No. 4,937,270). Polyhydrazides represent other nucleophilic reactants (WO 2006/001046). The method of hyaluronic acid crosslinking by means of a polyanhydride, poly(alkyloyl chloride), polyepoxide, and poly carbodiimide was disclosed in WO 00/46252. The reaction of bis carbodiimide with hyaluronic acid (WO 2005/067994) results in crosslinking by means of a reactive electrophilic agent. Crosslinking via redox reactions is disclosed in EP 1683812 A1, where disulphide bridges between thiol derivatives and hyaluronic acid are formed. Another specific crosslinking method is a photochemical reaction. It is well known that the vinylene group of cinnamic acid or an aryl-substituted analogue thereof is capable of photochemical cyclization to cyclobutane. This fact was used by the authors of EP 1217008 A1 who acylated the N-deacylated derivative of hyaluronic acid on the nitrogen of the glucosamine moiety of the polysaccharide with cinnamic acid chloride. The crosslinking itself was effected by radiation by the light having the wave length of 280 nm. Besides the cinnamic acid, it is possible to use other photo-reactive groups linked to the hyaluronic acid (WO 97/18224, EP 0763754 A2) which give rise to crosslinked derivatives due to the radiation by the light having an appropriate wave length. The patents aimed at hyaluronic acid acylation and crosslinking in the presence of a base or in a basic solvent were published by Yui et al. (U.S. Pat. No. 6,673,919) and Nguyen et al. (U.S. Pat. No. 5,690,961).

Preparation of O-acyl-O′-alkyl carbonates

The classic method of the preparation of acyl alkyl carbonates is the reaction of carboxylic acids with alkyl chloroformates in the presence of a base (most frequently tertiary amine-triethylamine (TEA), pyridine, N-methyl morpholine, N-methylpyridine, diaza-bicyclo-undecene) (J. Org. Chem. 26(7), 1961, 2161), in the presence of a polar aprotic solvent (J. Org. Chem., 1958, 23(8), 1149-1152). Solvents that are used most often include diethylether (J. Org. Chem., 1959, 24(6), 774-778), toluene (J. Org. Chem., 1958, 23(8), 1149-1152), tetrahydro furane (J. Org. Chem., 1960, 25(10), 1703-1707; J. Am. Chem. Soc. 1967, 89(19), 5012-5017), chloroform, dimethyl amino formamide (European Patent 0700973, J. Am. Chem. Soc. 1952, 74, 676), N-methylpyrrolidine and N,N′-dimethylacetamide (U.S. Pat. No. 5,550,225, Aug. 27, 1996). The reaction is often performed at a lowered temperature between 0° C. and −10° C. This is due to the risk of a decomposition of the acylalkyl carbonates that are formed.

Tarbell has proven in a series of studies that the compounds are mostly stable and in many cases they may be isolated in their pure form (J. Org. Chem., 1957, 22(3), 245-250). In case of acylalkyl carbonates, the isolation also includes the process of washing the reaction mixture with NaHCO₃ solution, distilled water and HCl solution. This indicates that some of the acylalkyl carbonates are highly resistant to bases and acids at room temperature. Tarbell has also shown in his studies that the preparation of acylalkyl carbonates by means of the reaction of alkyl chloroformate with a carboxylic acid may be preformed at room temperature, optionally in boiling diethylether.

This traditional method of preparation was also modified for the realization in an aqueous medium (Patent No. DE 1,133,727). The respective acid is dissolved in water and is neutralized by NaOH solution. The base (N,N-dimethyl cyclohexylamine, N,N-dimethyl aminopyridine, methylamine, NH₃) and alkyl chloroformate are added to the solution. The reaction takes place at 0° C. and the reaction pH is maintained between 6 and 7. The drawback of this method is the competitive reaction of acylalkyl carbonates with the alcohol that is formed. A preferred reaction medium is an inert solvent, e.g. chloroform (J. Org. Chem. 1995, 60, 7072-7074).

Acylation of hydroxy-compounds by means of O-acyl-O′-alkyl carbonates

Acylalkyl carbonates have been used as acylating agents in the preparation of amides since the beginning of the 50's of the 20^{th} century (J. Am. Chem. Soc., 1951, 73(7), 3547-3547). As they were considered as instable compounds, they were generated during the reaction in situ. However, a more detailed study of this type of compounds suggested that the compounds might be stable, especially if the acylalkyl carbonates were derived from carboxylic acids having a high melting point (J. Org. Chem., 1958, 23(8), 1149-1152). Later on, quite a number of acylalkyl carbonates have been prepared and isolated, including various types of substitutions both in the acyl and in the carbonate part of the molecule. Further, it was proven that in many cases the compounds were very stable. E.g. their thermal decomposition often occurs at temperatures significantly exceeding 100° C. However, this is true only provided that the catalytic effect of bases or solvents is excluded (J. Org. Chem., 1959, 24(6), 774-778).

Generally, it can be stated that the stability of acylalkyl carbonates shows a dependence on the pKa of the carboxylic acid. The stability of acylalkyl carbonates was given much attention and based on many studies, a model was drawn up in which the mechanism of their decomposition was disclosed (J. Org. Chem. Volume 26, Number 7, 1961, 2161; J. Org. Chem., 1958; 23(8), 1149-1152; J. Org. Chem., 1959, 24(6), 774-778; J. Org. Chem., 1960, 25(10), 1703-1707; J. Org. Chem., 1964, 29(5), 1168-1169; J. Org. Chem., 1967, 32, 2188-2193; J. Org. Chem. Volume 26, Number 7, 1961, 2161; J. Org. Chem., 1958, vol. 23, p. 1152; J. Am. Chem. Soc.; 1962, 84(21), 4113-4115; J. Org. Chem., 1958, 23(12), 2044.; J. Org. Chem., 1964, 29(11), 3422-3423.). There are two pathways leading to the decomposition of acylalkyl carbonates which compete. The shift leads to the formation of an ester and to the release of CO₂, while the disproportionating reaction give rise, besides CO₂, also to a symteric anhydride and dialkylcarbonate.

The structure of acylalkyl carbonates implies that there are two centers in the molecule which can be the subject to a nucleophilic attack—the carboxyl carbonyl center and the carbonate carboxyl center. The ratio of the rates of both competing reactions and the ratio of the formation of the decomposition products are determined by the substitution type of both centers (J. Org. Chem., 1959, 24(6), 774-778; J. Org. Chem., 1960, 25(10), 1703-1707; J. Org. Chem. Volume 26, Number 7, 1961, 2161). It was proven that this ratio depends neither on the dilution, nor on the temperature and nor on the presence of a base. These factors may only influence the rate of the process as a whole (J. Org. Chem., 1960, 25(10), 1703-1707; J. Org. Chem. Volume 26, Number 7, 1961, 2161).

On the other hand, there are various opinions regarding the use of the classic O-acylating agents. A significant drawback of the use of the mixed anhydrides in this type of reactions consists in side reactions taking place of the unreacted acylalkyl carbonate with the alcohol which is released by the decomposition of the carbonate (J. Org. Chem., 1957, 22(3), 245-250). This undesired effect may be prevented by using a high excess of alcohol the ester of which we are going to prepare (an ideal situation is when we can use the alcohol as the solvent—J. Org. Chem. 1995,60, 7072-7074) or by using an initial acylalkyl carbonate comprising a secondary or tertiary alcohol.

In spite of the above mentioned drawbacks there is a number of examples in the patent literature where acylalkyl carbonates are used as the classic O-acylating agents. Philipe discloses in his patent (U.S. Pat. No. 5,550,225) a regio-selective acylation of D-maltose by means of fatty acid mixed anhydrides, forming D-maltose monoesters in the position 6′. The activation of the acids is most frequently performed by triethylamine, pyridine, 4-dimethylaminopyridine, tributylamine, or N-methylmorpholine, in the presence of alkyl chloroformate (e.g. isopropyl chloroformate) in an organic solvent, e.g. tetrahydrofurane. The acylation itself is performed in an anhydrous pyridine at room temperature. The drawback of this method is the toxicity of pyridine and the low solubility of hyaluronic acid in pyridine. The patent literature also discloses methods of polyol acylation, using water as the reaction medium. In his patents (U.S. Pat. No. 5,498,708; WO 91/01322) Lalezari discloses a method in which the reaction takes place in a water-ice mixture in which the respective acid, triethylamine, alkyl chloroformate and saccharide are dissolved. U.S. Pat. No. 5,498,708 includes polyalcohols having the carbon chain with three and more hydroxy moieties bound thereto, as from simple trioles such as gylcerol, to polysaccharides such as starch, cellulose, amylose, insulin or agar. the substitutes on the oxygen of chloroformate can include alkyls having 2-10 carbon atoms or aryls. The experimental part mentions the preparation of the mixed anhydride itself in the presence of triethylamine in an ice water. The prepared agent is present in the esterification reaction taking place at room temperature in water in a 4 to 10 fold excess compared to the esterified saccharide.

The use of acylalkyl carbonates as esterification agents in an aqueous medium is disclosed also as the way of preparation of structurally modified starches (U.S. Pat. No. 3,720,662). The reaction is performed at mild conditions (20 to 40° C.) and the method requires maintaining the reaction pH within the range 7 to 9.5. The process may take place in a heterogenous phase (starch suspension) or even without using any solvent.

The Czech patent application No. PV 2006-605 discloses the method of modification of polysaccharides, especially hyaluronic acid (HA), by substitution of —OH moiety of the saccharide by —O—CO—R moiety by means of acylalkyl carbonates in a polar aprotic medium in the presence of an organic base:

R—CO—O—CO—O—R₁+HA-OH→HA-O—CO—R+CO₂+R₁OH (reaction 1).

This reaction runs just a very little and that's why the drawback of PV 2006-605 lies in a very low substitution degree which also affects the characteristics of the final product that is modified just a little bit.

The methods described herein above disclose acylations of polysaccharides comprising free hydroxy groups on which the reaction takes place. The drawbacks of said methods include a low polymer substitution degree caused by the instability of the used agent (acylalkyl carbonate). Moreover, neither the fact that some acylations take place in a heterogenous system leads to a more significant modification. The method according to the invention relates to the modification of hyaluronic acid, takes place in a homogenous system and yields significantly higher substitution degrees compared to the known analogues.

### DISCLOSURE OF THE INVENTION

The subject-matter of the invention is a method, of the preparation of hyaluronic acid derivatives by means of the complex (O-acyl-O′-alkyl carbonate—substituted pyridine) in an aprotic medium. The reaction takes place in DMSO in the presence of an external base, forming O-acylated products. Hyaluronic acid in the method of the invention is preferably in the form of a free acid, has the molecular weight within the range from 1·10⁴ to 5·10⁶ g.mol⁻¹, preferably 10⁵ g.mol⁻¹, and polydispersity index within the range from 1.02 to 5.0. All of the molecular weights of the hyaluronic acid and the derivatives thereof mentioned herein are weight average molecular weights. The hyaluronic acid may be in the form of salts, e.g. sodium, potassium, calcium or other salt. The aprotic medium includes DMSO as a solvent, and a base. The method leads to higher substitution degrees and shorter reaction times, compared to the known analogues. Bonding of the acyl moiety to the polysaccharide by means of an esteric bond takes place at 20 to 80° C., preferably at 20° C. In case of the absence of substituted pyridine, significantly lower substitution degrees have been observed. The acylation takes place either directly at some of the hydroxy groups, or on the carboxylate group of the glucuronic part of the polysaccharide and subsequently in an intramolecular way on the hydroxy group—see Scheme 1.

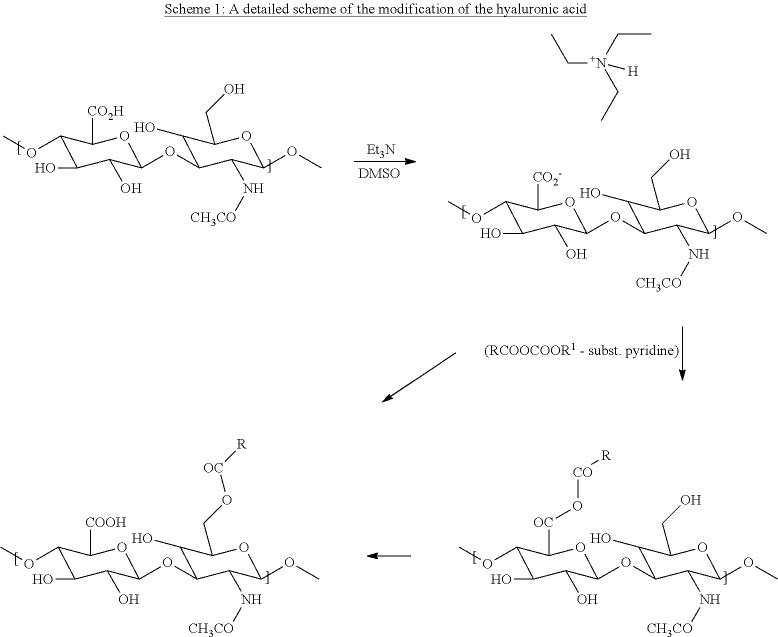

In the method according to the invention, a pure acylalkyl carbonate is prepared at the temperature of −40° C. to 0° C., preferably at −15° C. in ether, acetone or dichloromethane, by means of a reaction of the respective carboxylic acid with alkylchloroformate or an analogue thereof wherein the halogen is replaced by another leaving group (substituted quinoline, isoquinoline or 1,2-dihydro analogues thereof). The hyaluronic acid is dissolved in a polar aprotic solvent, preferably in DMSO, followed by the addition of a base, preferably triethylamine, a substituted pyridine, preferably 4-N,N-dialkylaminopyridine, and finally O-acyl-O′-alkyl carbonates. Then the resulting homogenous mixture is stirred without the access of air humidity at the temperature of 20 to 80° C., preferably at 20° C., for 0.1 hour to 96 hours, preferably for 1 hour.

O-acyl-O′-alkyl carbonates of the general formula R—CO—O—CO—O—R¹ include derivatives where R and R¹ have a linear or branched C₁-C₃₀ chain, optionally having aromatic or heteroaromatic groups. Preferably, the acylalkyl carbonates are first separately prepared and isolated and then added in their pure form into the reaction mixture comprising all the other reaction components such as DMSO, hyaluronic acid, base and the substituted pyridine. In analogue methods, the crude reaction mixture of fresh-prepared acylalkyl carbonates is added into the final reaction. The bases used include nitrogen organic bases of the general formula R₃N, wherein R is C₁-C₃₀ alkyl having a linear or branched chain, optionally comprising aromatic or heteroaromatic groups.

The substituted pyridine is known to significantly accelerate the decomposition of acylalkyl carbonates upon addition thereto, to the respective ester and CO₂, even at the temperatures around 0° C. (reaction 2)

R—CO—O—CO—O—R¹+DMAP→R—CO—O—R¹+CO₂ at low temperatures (reaction 2)

R—CO—O—R¹+HA-OH→HA-O—CO—R does not react (reaction 3)

Therefore, the use of the substituted pyridine for an acylation by means acylalkyl carbonates appears to be unsuitable to, the person skilled in the art since a fast decomposition of the agent (acylalkyl carbonate) that would not be able to acylate, is anticipated.

Thanks to the suitable selection of experimental conditions (reaction 5) for the method of the invention, the fast undesirable decomposition of O-acyl-O′-alkyl carbonates with substituted pyridine to nonreactive esters is avoided, while the acheived substitution degree is significantly higher than in the analogue examples known from the state of the art (reaction 4)

R—CO—O—CO—O—R¹+HA-OH→HA-O—CO—R reacts just a little (reaction 4)

HA-OH+base+subst.pyr.+R—CO—O—CO—O—R¹→HA-O—CO—R+CO₂+R¹OH (reaction 5)

In case the agent (acylalkyl carbonate) corresponds to the general formula R(CO—O—CO—O—R¹)ₙ, where n>1, i.e. the agent comprises two or more acylalkyl carbonate moieties, e.g. R(CO—O—CO—O—R¹)₂, crosslinked derivatives of hyaluronic acid are formed polymer-O—CO—R—CO—O-polymer.

### MODES FOR CARRYING OUT THE INVENTION

SD=substitution degree=100%·molar amount of the bound substitute/molar amount of all polysaccharide dimers

### Example 1

### Preparation of O-ethyl-0″-palmitoyl carbonate

Triethylamine (1,3 eq) was added to the solution of palmitic acid (1 g) in ether (50 ml) and the mixture was stirred for 5 minutes at room temperature. Then the mixture was cooled to −15° C. and ethylchloroformate (1,3 eq) was being added for 5 minutes, while the temperature had not exceeded −10° C. The resulting suspension was stirred for 2 hours while the mixture was slowly heated to −5° C., then it was quickly filtered off, the filtrate was evaporated and stored at −15° C.

¹³C NMR (CDCl₃) (8168 ppm —CO—O—COOEt, 148 ppm —COO—CO—OEt, 66 ppm —COO—CH₂—CH₃, 34 ppm —CH₂—COO—, 23-33 ppm —C—CH₂—C—, 15 ppm —COO—CH₂—CH₃, 14 ppm —CH₂—CH₂—CH₃).

¹H NMR (CDCl₃) δ 4.32 (q, 2H, —COO—CH₂—CH₃), 2.46 (t, 2H, —CH₂—COO—), 1.68 (m, 2H, —CH₂—CH₂—COO—), 1.63 (m, 2H, —CH₂—CH₂—CH₂—COO—), 1.37 (t, 3H, —COO—CH₂—CH₃), 1.25-1.40 (m, 22H, —C—CH₂—C—), 0.90 (t, 3H, —CH₂—CH₂—CH₃).

### Example 2

### Preparation of O-(2-anthraquinone carbonyl)-O′-ethyl carbonate

Triethylamine (1,3 eq) was added to the solution of 2-anthraquinone carboxyl acid (1 g) in acetone (50 ml) and the mixture was stirred for 5 minutes at room temperature. Then the mixture was cooled to −15° C. and ethylchloroformate (1,3 eq) was being added for 5 minutes, while the temperature had not exceeded −10° C. The resulting suspension was stirred for 2 hours while the mixture was slowly heated to −5° C., then it was quickly filtered off, the filtrate was evaporated and stored at −15° C.

¹³C NMR (CDCl₃) (δ 182 ppm C_{Ar}—CO—C_{Ar}, 181 ppm C_{Ar}—CO—C_{Ar}, 159 ppm C_{Ar}—COO—COM, 148 ppm C_{Ar}—COO—COOEt, 135-125 ppm —C_{Ar}, 62 ppm —COO—CH₂—CH₃, 15 ppm —COO—CH₂—CH₃).

### Example 3

### Preparation of O-(2-acetoxy benzoyl)-O′-ethyl carbonate

Triethylamine (1,3 eq) was added to the solution of acetylsalicylic acid (1 g) in ether (50 ml) and the mixture was stirred for 5 minutes at room temperature. Then the mixture was cooled to −15° C. and ethylchloroformate (1,3 eq) was being added for 5 minutes, while the temperature had not exceeded −10° C. The resulting suspension was stirred for 2 hours while the mixture was slowly heated to −5° C., then it was quickly filtered off, the filtrate was evaporated and stored at −15° C.

¹³C NMR (CDCl₃) (δ 169 ppm —CO—O—COOEt, 158 ppm CH₃—CO—, 151 ppm Cₐᵣ—O—CO—, 149 ppm —COO—CO—OEt, 135 ppm Cₐᵣ, 132 ppm Cₐᵣ, 126 ppm Cₐᵣ, 124 ppm Cₐᵣ, 120 ppm Cₐₙ 66 ppm —COO—CH₂—CH₃, 21 ppm CH₃—CO—, 14 ppm —COO—CH₂—CH₃).

¹H NMR (CDCl₃) δ 8.04 (d, 1H, ArH-6), 7.64 (t, 1H, ArH-4), 7.32 (t, 1H, ArH-5), 7.12 (d, 1H, ArH-3), 4.38 (q, 2H, —COO—CH₂—CH₃), 2.35 (s, 3H, CH₃—CO—), 1.40 (t, 3H, —COO—CH₂—CH₃)

### Example 4

### Preparation of O,O′-bis(etoxycarbonyl) adipate

Triethylamine (2,6 eq) was added to the solution of adipic acid (1 g) in ether (50 ml) and the mixture was stirred for 30 minutes at room temperature. Then the mixture was cooled to −15° C. and ethylchloroformate (2,6 eq) was being added for 5 minutes, while the temperature had not exceeded −10° C. The resulting suspension was stirred for 2 hours while the mixture was slowly heated to −5° C., then it was quickly filtered off, the solid part was washed 3× with 30 ml of cool ether, the filtrate was evaporated and stored at −15° C.

¹³C NMR (CDCl₃) (δ 167 ppm —CO—O—COOEt, 149 ppm —COO—CO—OEt, 66 ppm —COO—CH₂—CH₃, 34 ppm —CO—CH₂—CH₂—, 23 ppm —CO—CH₂—CH₂—, 14 ppm —COO—CH₂—CH₃).

¹H NMR (CDCl₃) δ 4.30 (q, 2H, —COO—CH₂—CH₃), 2.49 (m, 2H, —CO—CH₂—CH₂A 1.74 (m, 2H, —CO—CH₂—CH₂—), 1.40 (f, 3H, —COO—CH₂—CH₃)

### Example 5

### Acylation of the Hyaluronic Acid by Means of O-ethyl-O′-palmitoyl carbonate

Triethylamine (4 eq) and 4-dimethyl aminopyridine (0.4 eq) were added to the solution of hyaluronic acid (0.10 g, 20 kDa) in dimethylsulfoxide (10 ml) and the mixture was stirred for 1 hour at room temperature. Then O-ethyl-O′-palmitoyl carbonate (2 eq, Example 1) was added to the resulting solution and the mixture was stirred at the temperature of 20° C. for 1 hour without the access of air humidity. Then the solution was cooled to room temperature, twenty times the amount of demineralized water was added and the mixture was dialyzed 7 times against 5 l of demineralized water. The resulting solution was filtered and evaporated to yield 0.095 g of the product in form of a transparent film.

SD 5% (determined from NMR, see Example 8 for more detail)

### Example 6

### Acylation of the hyaluronic acid by means of O-ethyl-O′-palmitoyl carbonate

Triethylamine (4 eq) and 4-dimethyl aminopyridine (2 eq) were added to the solution of hyaluronic acid (0.10 g, 20 kDa) in dimethylsulfoxide (10 ml) and the mixture was stirred for 1 hour at room temperature. Then O-ethyl-O′-palmitoyl carbonate (2 eq, Example 1) was added to the resulting solution and the mixture was stirred at the temperature of 20° C. for 1 hour without the access of air humidity. Then the solution was cooled to room temperature, twenty times the amount of demineralized water was added and the mixture was dialyzed 7 times against 5 l of demineralized water. The resulting solution was filtered and evaporated to yield 0.098 g of the product in form of a transparent film.

SD 15% (determined from NMR, see Example 8 for more detail)

### Example 7

### Acylation of the hyaluronic acid by means of O-ethyl-O′-palmitoyl carbonate

Triethylamine (4 eq) and 4-dimethyl aminopyridine (2 eq) were added to the solution of hyaluronic acid (0.10 g, 20 KDa) in dimethylsulfoxide (10 ml) and the mixture was stirred for 1 hour at room temperature. Then O-ethyl-O′-palmitoyl carbonate (2 eq, Example 1) was added to the resulting solution and the mixture was stirred at the temperature of 60° C. for 1 hour without the access of air humidity. Then the solution was cooled to room temperature, twenty times the amount of demineralized water was added and the mixture was dialyzed 7 times against 51 of demineralized water. The resulting solution was filtered and evaporated to yield 0.096 g of the product in form of a transparent film.

SD 10% (determined from NMR, see Example 8 for more detail)

### Example 8

### Acylation of the hyaluronic acid by means of O-ethyl-O′-palmitoyl carbonate

Triethylamine (4 eq) and 4-dimethyl aminopyridine (2 eq) were added to the solution of hyaluronic acid (0.10 g, 20 kDa) in dimethylsulfoxide (10 ml) and the mixture was stirred for 1 hour at room temperature. Then O-ethyl-O′-palmitoyl carbonate (2 eq, Example 1) was added to the resulting solution and the mixture was stirred at the temperature of 20° C. for 24 hours without the access of air humidity. Then the solution was cooled to room temperature, twenty times the amount of demineralized water was added and the mixture was dialyzed 7 times against 5 l of demineralized water. The resulting solution was filtered and evaporated to yield 0.098 g of the product in form of a transparent film.

SD 15% (determined from NMR)

Analytical data of the hyaluronan acylated with palmitic acid:

¹H NMR (D₂O) δ 4.28 (m, 2H, —COO—CH₂-polymer), 2.40 (m, 2H, —CH₂—COO—), 1.65 (m, 2H, —CH₂—CH₂—COO—), 1.60 (m, 2H, —CH₂—CH₂—CH₂—COO—), 1.25-1.40 (m, 22H, —C—CH₂—C—), 0.90 (m, 3H, —CH₂—CH₂—CH₃).

DOSY NMR (D₂O) logD (2.0 ppm, CH₃—CO—NH-polymer)˜−11.3 m²/s
logD (1.65 ppm, —CH₂—CH₂—COO—)˜−11.5 m²/s
logD (1.25-1.40 ppm, —C—CH₂—C—)˜−11.5 m²/s,
logD (H₂O)˜−8.6 m²/s,

IR(KBr)1735 cm⁻¹

### Example 9

### Acylation of the hyaluronic acid by means of O, O′-bis(ethoxycarbonyl) adipate

Triethylamine (4 eq) and 4-dimethyl aminopyridine (0.2 eq) were added to the solution of hyaluronic acid (0.10 g, 30 kDa) in dimethylsulfoxide (10 ml) and the mixture was stirred for 1 hour at room temperature. Then O, O′-bis(ethoxycarbonyl) adipate (2 eq, Example 4) was added to the resulting solution and the mixture was stirred at the temperature of 20° C. for 1 hour without the access of air humidity. Then the solution was cooled to room temperature, twenty times the amount of demineralized water was added and the mixture was dialyzed 7 times against 5 l of demineralized water. The resulting solution was filtered and evaporated to yield 0.1 g of the product in form of a transparent film.

SD 5% (determined from NMR, see Example 11 for more detail)

### Example 10

### Acylation of the hyaluronic acid by means, of O, O′-bis(ethoxycarbonyl) adipate

Triethylamine (4 eq) and 4-dimethyl aminopyridine (2 eq) were added to the solution of hyaluronic acid (0.10 g, 2000 kDa) in dimethylsulfoxide (20 ml) and the mixture was stirred for 1 hour at room temperature. Then O, O′-bis(ethoxycarbonyl) adipate (2 eq, Example 4) was added to the resulting solution and the mixture was stirred at the temperature of 60° C. for 1 hour without the access of air humidity. Then the solution was cooled to room temperature, twenty times the amount of demineralized water was added and the mixture was dialyzed 7 times against 5 l of demineralized water. The resulting solution was filtered and evaporated to yield 0.11 g of the product in form of a transparent film.

SD 20% (determined from NMR, see Example 11 for more detail)

### Example 11

### Acylation of the hyaluronic acid by means of O, O′-bis(ethoxycarbonyl) adipate

Triethylamine (4 eq) and 4-dimethyl aminopyridine (2 eq) were added to the solution of hyaluronic acid (0.10 g, 30 kDa) in dimethylsulfoxide (10 ml) and the mixture was stirred for 1 hour at room temperature. Then O, O′-bis(ethoxycarbonyl) adipate (2 eq, Example 4) was added to the resulting solution and the mixture was stirred at the temperature of 20° C. for 1 hour without the access of air humidity. Then the solution was cooled to room temperature, twenty times the amount of demineralized water was added and the mixture was dialyzed 7 times against 5 l of demineralized water. The resulting solution was filtered and evaporated to yield 0.12 g of the product in form of a transparent film.

SD 50% (determined from NMR)

Analytical data of the hyaluronan acylated with adipic acid:

¹H NMR (D₂O) δ 4.27 (m, 2H, —COO—CH₂-polymer), 2.43 (m, 4H, —CO—CH₂—CH₂—), 1.68 (m, 4H, —CO—CH₂—CH₂—)

DOSY NMR (D₂O) logD (2.0 ppm, CH₃—CO—NH-polymer)˜−11.0 m²/s
logD (2.43, —CO—CH₂—CH₂—)˜−11.0 m²/s
logD (1.68, —CO—CH₂—CH₂—)˜−11.0 m²/s
logD (H₂O)-8.6 m²/s

IR(KBr) 1738 cm⁻¹

GPC SEC-MALLS Mw of the product 1600 kDa (1600 kg.mol⁻¹)

### Example 12

### Acylation of the hyaluronic acid by means of O-(2-anthraquinone carbonyl)-O′-ethyl carbonate

Triethylamine (4 eq) and 4-dimethyl aminopyridine (2 eq) were added to the solution of hyaluronic acid (0.10 g, 30 kDa) in dimethylsulfoxide (10 ml) and the mixture was stirred for 1 hour at room temperature. Then O-(2-anthraquinone carbonyl)-O′-ethyl carbonate (2 eq, Example 2) was added to the resulting solution and the mixture was stirred at the temperature of 20° C. for 24 hours without the access of air humidity. Then the solution was cooled to room temperature, twenty times the amount of demineralized water was added and the mixture was dialyzed 7 times against 5 l of demineralized water. The resulting solution was filtered and evaporated to yield 0.1 g of the product in form of a transparent film.

SD 5% (determined from NMR, see Example 13 for more detail)

### Example 13

### Acylation of the hyaluronic acid by means of O-(2-anthraquinone carbonyl)-O′-ethyl carbonate

Triethylamine (4 eq) and 4-dimethyl aminopyridine (2 eq) were added to the solution of hyaluronic acid (0.10 g, 200 kDa) in dimethylsulfoxide (10 ml) and the mixture was stirred for 1 hour at room temperature. Then O-(2-anthraquinone carbonyl)-O′-ethyl carbonate (2 eq, Example 2) was added to the resulting solution and the mixture was stirred at the temperature of 20° C. for 24 hours without the access of air humidity. Then the solution was cooled to room temperature, twenty times the amount of demineralized water was added and the mixture was dialyzed 7 times against 5 l of demineralized water. The resulting solution was filtered and evaporated to yield 0.1 g of the product in form of a transparent film.

SD 5% (determined from NMR)

Analytical data of the hyaluronan acylated with adipic acid:

¹H NMR (D₂O) δ 8.85 (m, 1H, ArH-1), 8.50 (m, 111, ArH-3), 8.40 (m, 1H, ArH-4), 8.36 (m, 2H, ArH-5,8), 7.97 (m, 2H, ArH-6,7), 4.32 (m, 211, —COO—CH₂-polymer)

IR(KBr) 1738 cm⁻¹

GPC SEC-MALLS UV active substance bound to the polymer (UV detector 280 nm)

### Example 14

### Acylation of the hyaluronic acid by means of O-(2-acetoxybenzoyl)-O′-ethyl carbonate

Triethylamine (4 eq) and 4-dimethyl aminopyridine (2 eq) were added to the solution of hyaluronic acid (0.10 g, 30 KDa) in dimethylsulfoxide (10 ml) and the mixture was stirred for 1 hour at room temperature. Then O-(2-acetoxybenzoyl)-O′-ethyl carbonate (2 eq, Example 3) was added to the resulting solution and the mixture was stirred at the temperature of 20° C. for 24 hours without the access of air humidity. Then the solution was cooled to room temperature, twenty times the amount of demineralized water was added and the mixture was dialyzed 7 times against 5 l of demineralized water. The resulting solution was filtered and evaporated to yield 0.1 g of the product in form of a transparent film.

SD 10% (determined from NMR, see Example 16 for more detail)

### Example 15

### Acylation of the hyaluronic acid by means of O-(2-acetoxybenzoyl)-O′-ethyl carbonate

Triethylamine (4 eq) and quinoline (2 eq) were added to the solution of hyaluronic acid (0.10 g, 200 kDa) in dimethylsulfoxide (10 ml) and the mixture was stirred for 1 hour at room temperature. Then O-(2-acetoxybenzoyl)-O′-ethyl carbonate (2 eq, Example 3) was added to the resulting solution and the mixture was stirred at the temperature of 60° C. for 24 hours without the access of air humidity. Then the solution was cooled to room temperature, twenty times the amount of demineralized water was added and the mixture was dialyzed 7 times against 5 l of demineralized water. The resulting solution was filtered and evaporated to yield 0.1 g of the product in form of a transparent film.

SD 10% (determined from NMR)

### Example 16

### Acylation of the hyaluronic acid by means of O-(2-acetoxybenzoyl)-O′-ethyl carbonate

Triethylamine (4 eq) and 4-dimethyl aminopyridine (2 eq) were added to the solution of hyaluronic acid (0.10 g, 200 kDa) in dimethylsulfoxide (10 ml) and the mixture was stirred for 1 hour at room temperature. Then O-(2-acetoxybenzoyl)-O′-ethyl carbonate (2 eq, Example 3) was added to the resulting solution and the mixture was stirred at the temperature of 60° C. for 24 hours without the access of air humidity. Then the solution was cooled to room temperature, twenty times the amount of demineralized water was added and the mixture was dialyzed 7 times against 5 l of demineralized water. The resulting solution was filtered and evaporated to yield 0.1 g of the product in form of a transparent film.

SD 10% (determined from NMR, see Example 16 for more detail)

Analytical data of the hyaluronan acylated with adipic acid:

¹H NMR(H2O) δ 8.01 (m, 111, ArH-6), 7.55 (m, 1H, ArH-4), 7.28 (m, 1H, ArH-5), 7.05 (m, 1H, ArH-3), 4.28 (m, 211, —COO—CH₂-polymer)

GPC SEC-MALLS UV active substance bound to the polymer (UV detector 270 nm)

1. A method of preparation of hyaluronic acid derivatives comprising:
reacting hyaluronic acid with the complex (O-acyl-O′-alkyl carbonate—substituted pyridine) in an aprotic medium.

2. The method of preparation according to claim 1 wherein the hyaluronic acid is in the form of a free acid or a salt.

3. The method of preparation according to claim 1 wherein the hyaluronic acid has the molecular weight within the range from 1·10⁴ to 5·10⁶ g.mol⁻¹ and the polydispersity index within the range from 1.02 to 5.0.

4. The method of preparation according to claim 1 wherein the aprotic medium includes DMSO as a solvent, and a base.

5. The method of preparation according to claim 4 wherein the base includes nitrogen organic compounds of the general formula R₃N, wherein R is an alkyl linear or branched C₁-C₃₀ chain, optionally containing aromatic or heteroaromatic groups.

6. The method of preparation according to claim 1 wherein the reaction of the hyaluronic acid with the complex (O-acyl-O′-alkyl carbonate—substituted pyridine) takes place at the temperature within the range of 20° C. to 80° C. for at least 1 minute.

7. The method of preparation according to claim 1 wherein the O-acyl-O′-alkyl carbonates include compounds of the general formula R(CO—O—CO—O—R¹)ₙ, wherein n is 1 to 7 and R, R¹ have a linear or branched C₁-C₃₀ chain, optionally containing aromatic or heteroaromatic groups.

8. The method of preparation according to claim 1 wherein O-acyl-O′-alkyl carbonate is first prepared and isolated, then the reaction mixture comprising hyaluronic acid in an aprotic medium containing a solvent, a base and a substituted pyridine, is prepared separately, and then O-acyl-O′-alkyl carbonate in its pure form in an amount of at least 0.1 equivalent with respect to the polymer dimer is added to the reaction mixture.

9. The method of preparation according to claim 1 wherein the substituted pyridine is present in the reaction mixture in an amount within the range of 0.01 to 10 equivalents with respect to the polymer dimer.

10. The method of preparation according to claim 1 wherein the substituted pyridine comprises heteroaromatic organic compounds corresponding to the general formula I 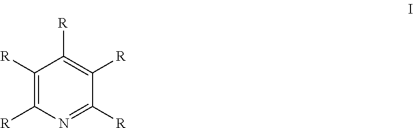
wherein R includes optionally hydrogen or alkyloxy, dialkylamino and alkyl groups, wherein alkyl represents an alkyl linear or branched C₁-C₃₀ chain, optionally containing aromatic or heteroaromatic groups.
